(19) United States
(12) Patent Application Publication
(10) Pub. No.: US 2025/0354540 A1
(43) Pub. Date: Nov. 20, 2025

(54) EXPANSIBLE HEAT PIPE ENGINE

(71) Applicant: Vince Kelly, Prescott, AZ (US)

(72) Inventor: Vince Kelly, Prescott, AZ (US)

(21) Appl. No.: 19/209,384

(22) Filed: May 15, 2025

Related U.S. Application Data
(60) Provisional application No. 63/648,925, filed on May 17, 2024.
(60) Provisional application No. 63/661,404, filed on Jun. 18, 2024.

(51) Int. Cl. F03G 4/00; F28F 27/00

(52) U.S. Cl. CPC F03G 4/00; F28F 27/006

(57) ABSTRACT

A regenerative heat pipe phase-change engine is disclosed, and may include an evaporator, a piston cylinder fluidically coupled to the evaporator, a piston configured to move within the piston cylinder, a condenser fluidically coupled to the piston cylinder, and a closed-loop fluid return system. The evaporator may be configured to absorb external thermal energy and to vaporize a working fluid within the evaporator. The piston may be configured to be driven by pressure exerted by the vapor generated in the evaporator. The condenser may be configured to condense the vapor into a condensate, such that a pressure differential is created between the condensate and the vapor. The closed-loop fluid return system may be configured to transport condensate from the condenser to the evaporator.

### BACKGROUND

### Technical Field

The present disclosure relates to a phase-change engine, specifically a phase-change engine utilizing a heat pipe.

### Description of the Related Art

Conventional phase-change engines require a separate boiler, piston, and condenser, and complex valve assemblies to manage the conversion of heat to mechanical energy. Such systems often entail intricate controls, significant maintenance, and external fluid management. In contrast, heat pipe technology offers highly efficient passive heat transfer through phase-change cycles. However, heat pipe technology is commonly employed in a closed-cycle vapor process for transferring heat without affecting mechanical energy.

### BRIEF SUMMARY

Embodiments described herein include regenerative heat pipe cylinders that are configured to integrate the evaporation, work, condensation, and fluid return processes into a unified regenerative system.

The regenerative heat pipe cylinder includes an evaporator configured to absorb external thermal energy and to vaporize a fluid within the evaporator, a piston cylinder, a piston configured to move within the piston cylinder, and a condenser fluidically coupled to the piston cylinder. The piston cylinder may be fluidically coupled to the evaporator. The piston may be configured to be driven by pressure exerted by the vapor generated in the evaporator. The condenser may be configured to condense the vapor into a condensate, such that a pressure differential is created between the condensate and the vapor. In some embodiments, the regenerative heat pipe cylinder may include a closed-loop fluid return system configured to transport condensate from the condenser to the evaporator.

In some embodiments, the evaporator may be configured to absorb thermal energy from one or more external sources selected from the group consisting of solar collectors, electric heaters, fuel powered heaters, geothermal heat, and waste heat recovery systems.

In some embodiments, the condenser may be configured to condense the vapor such that the working fluid undergoes a phase-change to a liquid, and such that at least a partial vacuum is generated in the piston cylinder.

In some embodiments, the closed-loop fluid return system may be configured to continuously recirculate the condensate to the evaporator by way of at least one of a gravity-assisted channel, capillary action, or a wick structure.

In some embodiments, the piston may be coupled to a modular mechanical system configured to convert mechanical energy produced by movement of the piston into electrical energy.

In some embodiments, a barrier may be positioned between the evaporator and the piston cylinder and may be configured to separate a thermal fluid in the evaporator and a working fluid in the piston cylinder. The barrier may be configured to enable heat transfer therethrough. The working fluid may be configured to be heated by the vaporized thermal fluid in the evaporator. The piston cylinder may be configured such that the heated working fluid cools or is removed to the condenser when the piston is in a fully extended position, and the piston may be configured to retract when the working fluid cools or is removed by way of reduced pressure exerted by the working fluid.

By combining a heat pipe evaporator with an integrated piston-cylinder-condenser assembly and a passive condensate return network, the system may operate continuously in a natural cycle. Among other benefits, aspects of the embodiments disclosed herein may reduce mechanical complexity, improve thermal efficiency, and support sustainable, off-grid power generation. The closed-loop nature and minimal moving parts make this design especially robust for off-grid and renewable energy applications. Also, the modularity of the design allows for scaling from small portable generators and motors to larger power and mechanical plants.

### BRIEF DESCRIPTION OF THE SEVERAL VIEWS OF THE DRAWINGS

FIG. 1 shows a cross-sectional view of an exemplary regenerative heat pipe cylinder including a piston in a retracted position according to the present disclosure.

FIG. 2 shows a cross-sectional view of the regenerative heat pipe cylinder of FIG. 1 including the piston in an extended position.

FIGS. 3A-3C show a detail cross-sectional view of a piston of a regenerative heat pipe cylinder according to another embodiment of the present disclosure.

FIG. 4 shows a cross-sectional view of a regenerative heat pipe cylinder according to another embodiment of the present disclosure.

FIG. 5 shows a side view of an exemplary regenerative phase-change engine according to the present disclosure.

FIG. 6 shows an annotated cross-sectional view of the exemplary regenerative heat pipe cylinder of FIG. 1.

FIG. 7 shows an annotated cross-sectional view of the exemplary regenerative heat pipe cylinder of FIG. 2.

FIG. 8 shows a cross-sectional view of a regenerative heat pipe cylinder including a piston in a retracted position according to another embodiment of the present disclosure.

FIG. 9 shows a cross-sectional view of the regenerative heat pipe cylinder of FIG. 8 including the piston in an extended position.

### DETAILED DESCRIPTION

In the following description, certain specific details are set forth in order to provide a thorough understanding of various disclosed embodiments. However, one skilled in the relevant art will recognize that embodiments may be practiced without one or more of these specific details. In other instances, well-known structures and techniques associated with phase-change engines may not be shown or described in detail to avoid unnecessarily obscuring descriptions of the embodiments.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

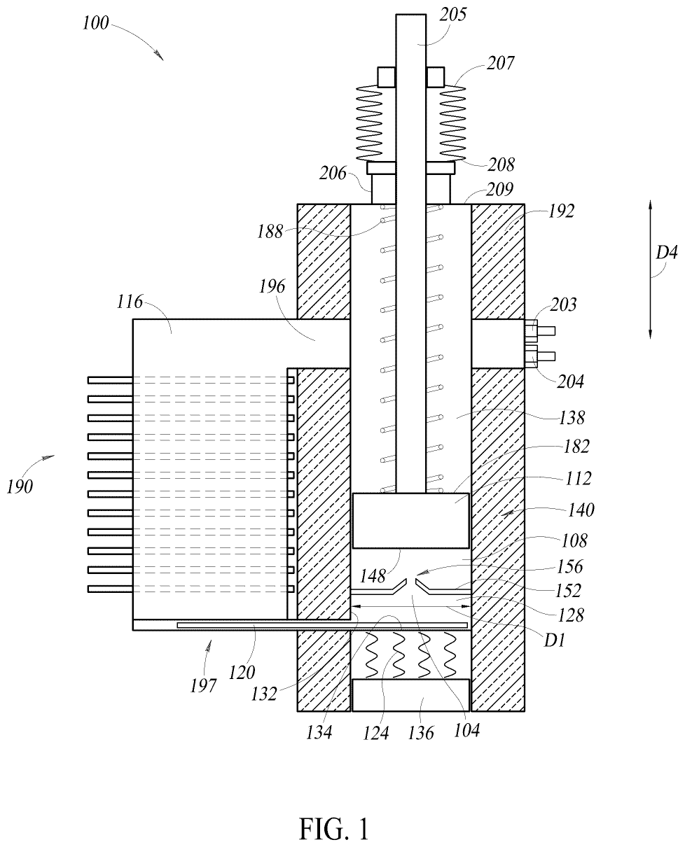

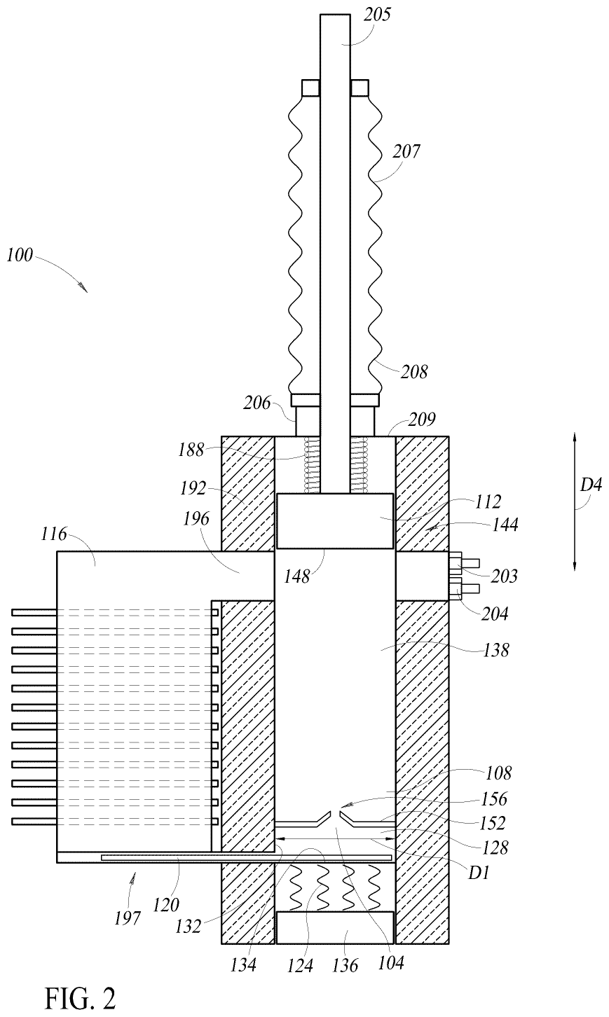

FIGS. 1 and 2 show a cross-sectional view of a regenerative heat pipe cylinder 100 according to a first embodiment. The regenerative heat pipe cylinder 100 produces mechanical work with minimal moving components and a closed-loop recirculation system. The regenerative heat pipe cylinder 100 includes an evaporator (i.e., a boiler) 104, a piston cylinder 108, a piston 112, a condenser 116, and a closed-loop fluid return system 120.

The evaporator 104 is configured to absorb external thermal energy 124 and to vaporize a working fluid within the evaporator 104. The evaporator 104 may define an inner chamber 128 in which the working fluid may be disposed during vaporization. Walls 132 defining the inner chamber 128 may be coated or constructed by high thermal conductivity material. The evaporator 104 may be configured to generally uniformly vaporize working fluid across a lateral dimension D1 of the evaporator. The evaporator 104 may be configured to absorb external energy 124 through the walls 132 or through a floor 134 of the evaporator 104.

The working fluid vaporized in the evaporator 104, and used throughout the regenerative heat pipe cylinder 100, may preferably comprise water. In some embodiments, the working fluid may comprise any of helium, nitrogen, ammonia, acetone, methanol, ethanol, mercury sodium, lithium, or silver. In some embodiments, the working fluid may expand by up to 1600 times its liquid volume. The regenerative heat pipe cylinder 100 may include enough working fluid such that a portion of the working fluid may be present at all times in each of the evaporator 104, the piston cylinder 108, and the condenser 116.

The external thermal energy 124 may be supplied to the evaporator 104 by way of any suitable external heat source 136, such as solar collectors, electric heaters, fuel powered heaters, geothermal heat, or waste heat sources. In other embodiments, the external thermal energy 124 may be provided by any suitable fuel-powered heater, including heaters powered by natural gas, propane, butane, diesel, gasoline, oil, coal, wood, geothermal, or hydrogen. In other embodiments, the external thermal energy 124 may be provided by a thermal storage system, such as sand, rock, or phase change salts.

The piston cylinder 108 may be positioned above and fluidically coupled to the evaporator 104, such that vapor created during vaporization may rise through the evaporator 104 and enter the piston cylinder 108.

The piston 112 may be disposed within a piston chamber 138 of the piston cylinder 108 such that the piston 112 may translate within the piston cylinder 108. The piston 112 is shown in a retracted position 140 in FIG. 1 and is shown in an extended position 144 in FIG. 2. The piston 112 may be driven from the retracted position 140 to the extended position 144 by pressure exerted by the vapor generated in the evaporator 104. The piston 112 may be configured such that the vapor generated by the evaporator 104 remains on an evaporator side 148 of the piston 112.

In some embodiments, such as the embodiments shown in FIGS. 1 and 2, the regenerative heat pipe cylinder 100 may include a restrictor plate 152 having an orifice 156 between the evaporator 104 and the piston cylinder 108. The restrictor plate 152 may separate the inner chamber 128 of the evaporator 104 and the piston chamber 138 of the piston cylinder 108. The vapor generated in the evaporator 104 may flow through the restrictor orifice 156 to enter the piston chamber 138 of the piston cylinder 108. The restrictor orifice 156 may be configured as a nozzle. The restrictor orifice 156 may be configured to regulate a vapor flow rate of the vapor from the evaporator 104 to the piston cylinder 108 and may control a pressure within the inner chamber 128 of the evaporator 104. The restrictor orifice 156 may be configured to optimize pressure, velocity, and kinetic energy of the vapor entering the piston chamber 138 in order to enhance the efficiency of the regenerative heat pipe cylinder 100. For example, a size of the restrictor orifice 156 may control an amount and velocity of the vapor entering the piston chamber 138. A larger nozzle used as the restrictor orifice 156 may increase the vapor flow rate and decrease the pressure within the inner chamber 128 of the evaporator, which may increase a speed of the piston 112 when moving from the retracted position 140 to the extended position 144.

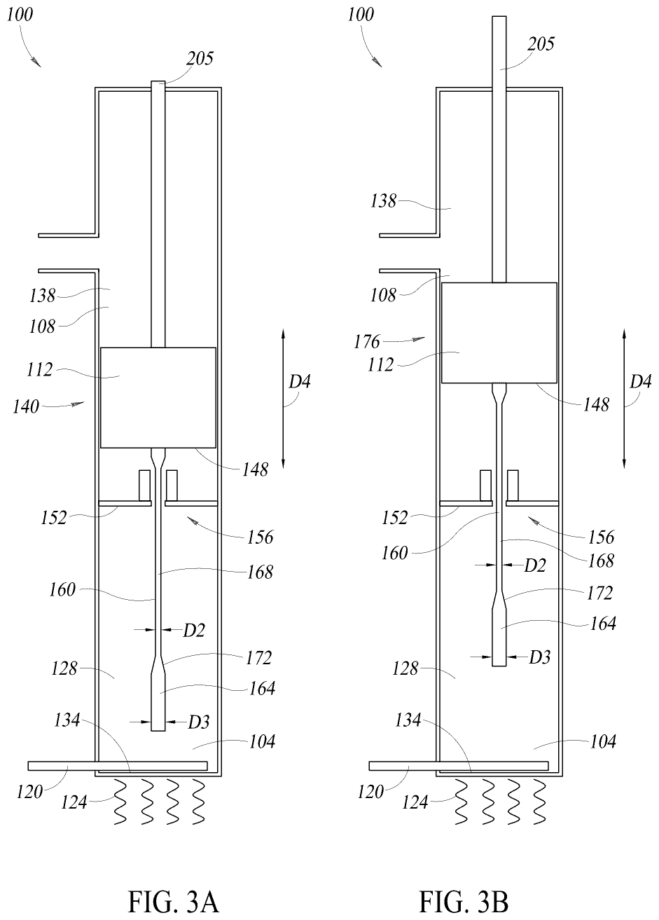

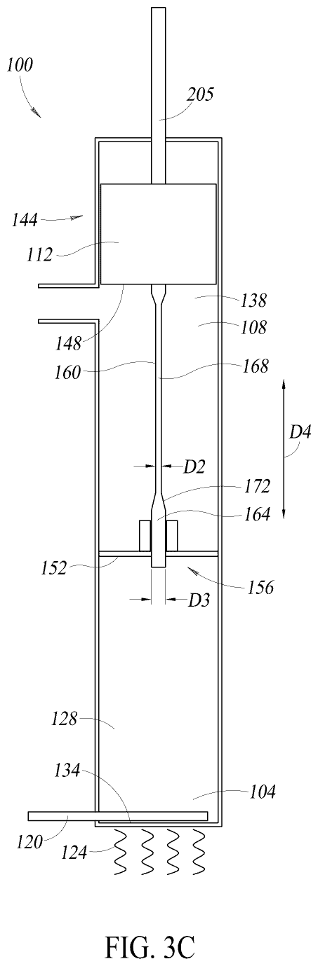

In some embodiments which include a restrictor plate 152, the piston 112 may include a valve shaft 160 extending from the evaporator side 148 of the piston 112. An exemplary valve shaft 160 is shown in FIGS. 3a through 3c. The valve shaft 160 may include a scaling portion 164 and a flow portion 168. A diameter D2 of the flow portion 168 may be smaller than a diameter D3 of the sealing portion 164. In some embodiments, the valve shaft 160 may be a single body in which the flow portion 168 is machined to have a smaller diameter D2 than the diameter D3 of the scaling portion 164. The valve shaft 160 may extend in a longitudinal dimension D4 from the piston 112 toward the floor 134 of the evaporator 104 to an extent such that when the piston 112 is in the extended position 144, the valve shaft 160 extends through the restrictor orifice 156. The diameter D3 of the scaling portion 164 of the valve shaft 160 may be sized and shaped such that when the scaling portion 164 is positioned within the restrictor orifice 156, the valve shaft 160 seals the restrictor orifice 156. The diameter D2 of the flowing portion 168 of the valve shaft 160 may be configured to enable vapor to flow through the restrictor orifice 156 when the flowing portion 168 is positioned within the restrictor orifice 156. In some embodiments, the flowing portion 168 of the valve shaft 160 may be tapered at a longitudinal end 172 thereof, such that when the longitudinal end 172 of the flowing portion 168 is positioned within the restrictor orifice 156, vapor may still flow therethrough.

In some embodiments, the flowing portion 168 may be positioned on the valve shaft 160 to be adjacent to the piston 112. In such embodiments, vapor may flow into the piston chamber 138 when the piston 112 is in the retracted position 140, as shown in FIG. 3a. As vapor flows into the piston chamber 138, the piston 112 may be driven toward away from the floor 134 of the evaporator 104 by way of the pressure exerted by the vapor on the piston 112. The piston 112 may reach a transition position 176, which is between the retracted position 140 and the extended position 144, and which is shown in FIG. 3b. In the transition position 176, the longitudinal end 172 of the flowing portion 168 may be positioned within the restrictor orifice 156. When in the transition position 176, vapor may continue to flow through the restrictor orifice 156. The piston 112 may continue to be driven toward the extended position 144, as shown in FIG. 3c. In the extended position, the sealing portion 164 of the valve shaft 160 may be positioned within the restrictor orifice 156. When in the extended position, the sealing portion 164 may prevent flow of the vapor from the evaporator 104 through the restrictor orifice 156 and to the piston chamber 138.

In some embodiments, the regenerative heat pipe cylinder 100 may not include a restrictor plate 152. Instead, in such embodiments, the piston chamber 138 may be a continuous extension of the inner chamber 128 of the evaporator 104, such that the piston cylinder 108 and the evaporator 104 form a continuous vapor channel.

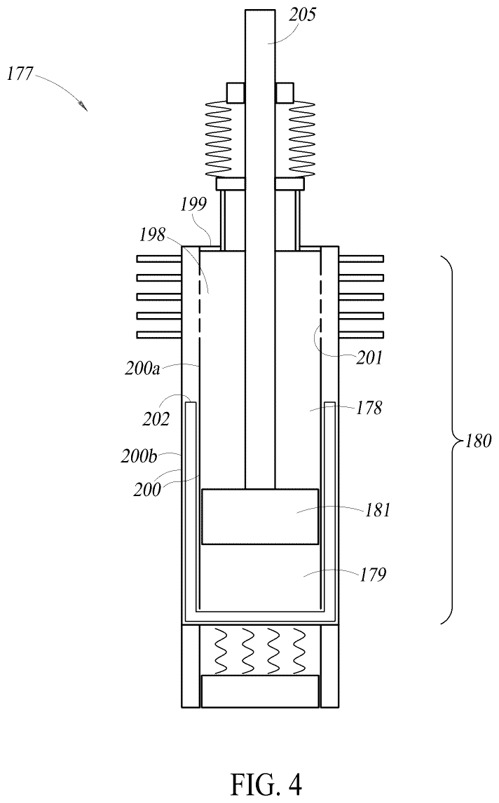

For example, an alternative embodiment of a regenerative heat pipe 177 is shown in FIG. 4 which does not include a restrictor plate. The regenerative heat pipe 177 generally performs the same function as regenerative heat pipe 100, except as stated herein. In the embodiment shown in FIG. 4, a piston chamber of a piston cylinder 178 and an inner chamber of an evaporator 179 form a single continuous chamber 180. In such embodiments, the vapor may freely rise to a piston 181 as the vaporization occurs.

Returning to the embodiment shown in FIGS. 1 and 2, a piston return enhancement mechanism 188 is included, which is included in some embodiments. A free side 182 of the piston 112, which is opposite the evaporator side 148 of the piston 112, may be in contact with the piston return enhancement mechanism 188, at least when the piston 112 is in the extended position 144. The piston return enhancement mechanism 188 may be configured to bias the piston 112 in the longitudinal dimension D4 toward the floor 134 of the evaporator 104 and may assist in returning the piston to the retracted position 140 from the extended position 144. In some embodiments, the piston return enhancement mechanism 188 is a mechanical spring.

The condenser 116 may be fluidically coupled to the piston cylinder 108 and may be configured to condense the vapor into a condensate, such that a pressure differential is created between the condensate in the condenser 116 and the vapor in the piston cylinder 108. The condenser 116 may be configured to condense the vapor such that the vapor undergoes a phase-change to a liquid, and such that latent heat may be released from the working fluid and at least a partial vacuum is generated in the piston cylinder 108. The partial vacuum generated in the piston cylinder 108 may facilitate the return of the piston 112 to the retracted position 140. The condenser 116 may be configured to be cooled to facilitate condensation. In some embodiments, the condenser 116 may be a heat exchanger. In some embodiments, the condenser 116 may be a coil condenser. In some embodiments, the condenser 116 may include thermal fins 190 to facilitate cooling. During condensing the volume of the working fluid may be reduced to as little as 1/1600 of the volume of the working when vaporized.

The condenser 116 may be separated from the piston cylinder 108 and the inner chamber 128 of the evaporator 104, as shown in FIGS. 1 and 2. For example, insulation 192 may be positioned between the condenser 116 and each of the piston cylinder 108 and the inner chamber 128. In such embodiments, a condenser channel 196 may fluidically couple the piston cylinder 108 to the condenser 116. The condenser channel 196 may be positioned such that the condenser channel 196 is exposed to the piston cylinder 108 on the evaporator side 148 of the piston 112 (i.e., the vapor in the piston cylinder 108) only when the piston 112 is in the extended position 144. In other words, the condenser channel 196 may be either above or directly next to the piston 112 when the piston is in any position other than the extended position 144. Such a positioning of the condenser channel 196 enables vapor to be withdrawn from the piston cylinder 108 when the piston is in the extended position 144, while preventing vapor from escaping the piston cylinder 108 when the piston is in the retracted position 140 or when transitioning between the retracted position 140 and the extended position 144. It should be understood that the condenser 116 may be positioned on a side 197 of the piston cylinder 108 and the evaporator 104, as in FIGS. 1 and 2, or may encircle the piston cylinder 108 and the evaporator 104.

In some embodiments, such as in the regenerative heat pipe cylinder 177 shown in FIG. 4, a condenser 198 may be incorporated into the piston cylinder 178, such that the condenser 198 forms a first end 199 of the single continuous chamber 180. In such an embodiment, the condenser 198 condenses vapor when the piston 181 reaches an extended position (not shown). The regenerative heat pipe cylinder 177 may include a pair of walls 200. An inner wall 200a of the pair of walls 200 may extend around a circumference of the piston cylinder 178. An outer wall 200b of the pair of walls 200 may extend around the inner wall 200a. The inner wall 200a may include perforations 201 on the first end 199 of the single continuous chamber 180 which are configured to enable condensed vapor to travel therethrough. The condensed vapor may then be returned to the evaporator 179 by way of a closed-loop fluid return system 202, which is described in detail below with reference to the regenerative heat pipe cylinder 100 shown in FIGS. 1 and 2. The closed-loop fluid return system 202 may extend, at least partially, between the pair of walls 200.

The closed-loop fluid return system 120 may be fluidically coupled to the condenser 116 and configured to transport the condensate from the condenser 116 to the evaporator 104. The closed-loop fluid return system 120 may be configured to continuously recirculate the condensate to the evaporator 104. Such a configuration enables continuous, self-sustaining operation. The partial vacuum driving the vapor to the condenser 116 may further drive the condensate through the condenser 116 to the closed-loop fluid return system 120. In some embodiments, the closed-loop fluid return system 120 may comprise a wick structure, as in the embodiments shown in FIGS. 1, 2, and 4. In some embodiments, the wick structure may extend across an entirety of the floor 134 of the evaporator 104 to enable even distribution of the working fluid across the evaporator 104. The wick structure may comprise any of copper braids, fiberglass blanket, carbon fiber weave, or stainless-steel wool. In some embodiments, the closed-loop fluid return system 120 may comprise a gravity-assisted channel. In some embodiments, the closed-loop fluid return system 120 may at least partly operate by way of capillary action. In some embodiments, the closed-loop fluid return system 120 may provide the working fluid to a reservoir within the evaporator 104.

The regenerative heat pipe cylinder 100 may further include a purge valve 203 fluidically coupled to any of the evaporator 104, the piston cylinder, 108, or the condenser 116. The purge valve 203 may be configured to selectively enable working fluid to be purged from the regenerative heat pipe cylinder 100. The purge valve 203 may also be fluidically couplable to a working fluid receptacle, and/or may be configured to purge the working fluid to the environment.

The regenerative heat pipe cylinder 100 may further include a feed valve 204 fluidically coupled to any of the evaporator 104, the piston cylinder, 108, or the condenser 116. The feed valve 204 may be configured to selectively provide working fluid to the regenerative heat pipe cylinder 100. The feed valve 204 may also be fluidically couplable to a working fluid source, from which the feed valve 204 may draw the working fluid to provide the working fluid to the regenerative heat pipe cylinder 100.

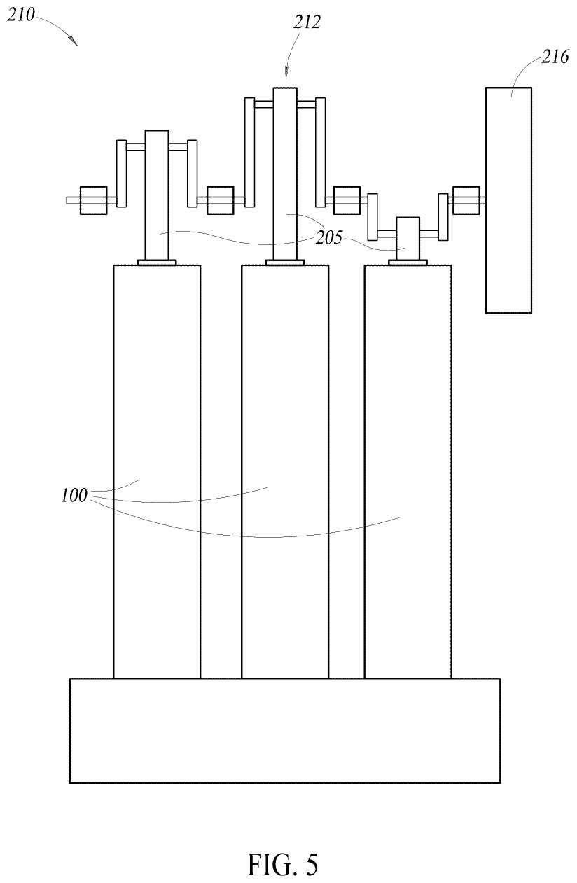

As shown in each of the embodiments of FIGS. 1 through 4, the piston 112 may include a piston rod 205 extending from the free side 182 of the piston 112. The piston rod 205 may couple to a transmission or energy transfer device, which will be discussed in further detail below with reference to FIG. 5.

In preferred embodiments, the regenerative heat pipe cylinder 100 is sealed and does not include any fluids other than the working fluid therein, such that the regenerative heat pipe cylinder 100 is a closed system. The closed system nature of the regenerative heat pipe cylinder 100 enables faster movement of the working fluid throughout the regenerative heat pipe cylinder 100. The piston rod 205 may extend through a stuffing box 206, which is configured to seal the piston cylinder 108 at the position where the piston rod 205 extends therefrom to maintain the closed system of the regenerative heat pipe cylinder 100. In some embodiments, the stuffing box 216 may include a stationary plate attached to the piston cylinder 108 configured to enable the piston shaft 205 to pass therethrough. Appropriate packing (e.g., glass-graphite or PTFE) may be coiled within the housing with a movable plate and a compression spring above. The compression spring may provide constant force to the packing as the packing moves with wear. A second movable plate with a hollow load cell may be positioned above the compression spring. An adjustable pressure plate may be positioned above the load cell and may be configured to accurately apply a specified pressure to the packing. The pressure to be applied to the packing may be determined at least in part by output from the load cell. The adjustable pressure plate is configured to apply pressure such that the stationary plate remains stationary. A thermoelectric generator (TEG) may be configured to receive the thermal energy 124, and may provide electricity to the load cell and the pressure plate. When the load cell provides a measurement outside of a predetermined range, a warning may be deployed. The warning may be deployed to alert a user that sealing within the stuffing box 216 is in need of replacement or maintenance.

Further, a pressure barrier 207 may be positioned on the piston rod 205 to further prevent atmospheric air from entering the regenerative heat pipe cylinder 100. The pressure barrier 207 may be configured as a bellow. The pressure barrier 207 may comprise silicone and/or rubber. A first end 208 of the pressure barrier 207 may be coupled to an exterior 209 of the piston cylinder 108 and/or the stuffing box 206. A second end of the pressure barrier 207 may couple to the piston rod 205. The pressure barrier 207 may extend when the piston 112 is in the extended position 144 and may retract when the piston 112 is in the retracted position 140, by way of the coupling to the piston cylinder 108 and the piston rod 205.

In other embodiments, the piston rod 205 and the free side 182 of the piston 112 may be exposed to atmospheric pressure.

At least one regenerative heat pipe cylinder 100 may be included in a regenerative phase-change engine 210, an example of which is shown in FIG. 5. As shown in the embodiment shown in FIG. 5, the regenerative heat pipe cylinder 100 may be coupled to a modular mechanical system 212 configured to convert mechanical energy produced by movement of the piston 112 into electrical energy. For example, the modular mechanical system 212 may be a crankshaft which is coupled to, and driven by, the piston rod(s) 205 of the at least one regenerative heat pipe cylinder 100. The crankshaft 212 may rotate by way of the motion of the piston(s) 112 of the at least one regenerative heat pipe cylinder 100. The modular mechanical system 212 may be coupled to a generator 216 configured to receive mechanical work from the modular mechanical system 212 and to convert the mechanical work to electrical energy. In other embodiments, the modular mechanical system 212, may be configured to convert mechanical energy into hydraulic or pneumatic energy. In some embodiments, the modular mechanical system 212 may be coupled to a device for performing the mechanical work in place of the generator 216. For example, the modular mechanical system 212 may be coupled to a shaft configured to rotate and drive a separate machine.

It should be understood that the modular mechanical system 212 may be any suitable system for transferring mechanical work received from the at least one regenerative heat pipe cylinder 100. Although FIG. 5 shows the modular mechanical system 212 in the form of a crankshaft, the modular mechanical system 212 may alternatively be any of a swashplate, a transmission, or a gear system.

In some embodiments, the piston rod 205 of the regenerative heat pipe cylinder 100 may be directly coupled to the generator 216 or a mechanical work output machine. For example, the piston rod 205 may be directly coupled to a linear alternator, such that the piston rod 205 is configured to drive the linear alternator to produce electrical energy.

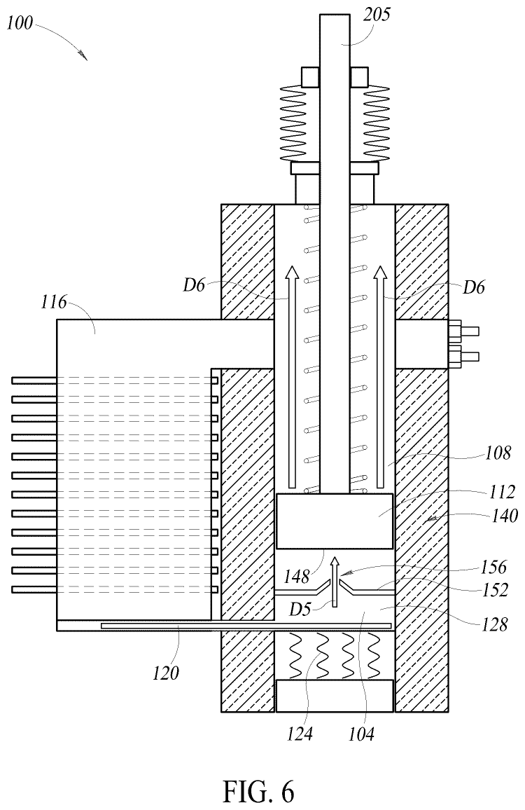

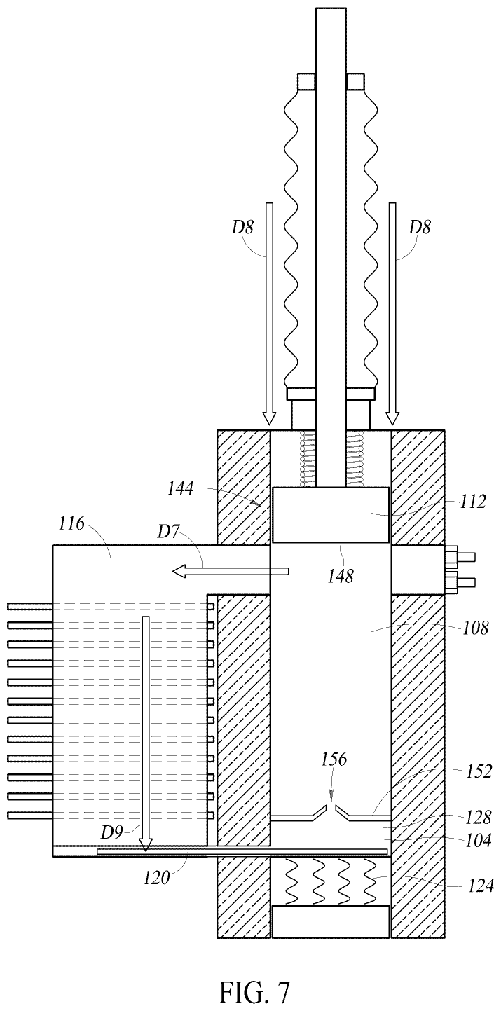

FIGS. 6 and 7 are annotated views of the regenerative heat pipe cylinder 100 when the piston 112 is in the retracted position 140 and the extended position 144, to show the flow of working fluid throughout the regenerative heat pipe cylinder 100 during use thereof. The method of producing mechanical work by way of the regenerative heat pipe cylinder 100 is described below with reference to FIGS. 6 and 7.

The method may begin by vaporizing the working fluid within the inner chamber 128 of the evaporator 104 when the piston 112 is in the retracted position 140, as shown in FIG. 6. The rise in temperature and/or latent heat of the vapor caused by the input of thermal energy 124 to the evaporator 104 may cause the vaporized working fluid to increase in pressure and to rise into the piston cylinder 108. The vaporized working fluid may rise and expand through the restrictor orifice 156 of the restrictor plate 152 to move from the inner chamber 128 of the evaporator 104 to the piston cylinder 108 in direction D5.

As the vaporized working fluid expands into the piston cylinder 108 on the evaporator side 148 of the piston 112, the pressure exerted by the working fluid may drive the piston 112 in direction D6, which may be a direction opposite the evaporator 104. The working fluid may drive the piston 112 until the piston 112 is placed in the extended position 144, as shown in FIG. 7. Such movement of the piston 112 exerts mechanical work, which may be transferable from the piston rod 205 to an external system, such as the modular mechanical system 212 shown in FIG. 5.

When the piston 112 reaches the extended position 144 shown in FIG. 7, the vaporized working fluid may flow into the condenser 116 in direction D7, at least in part due to the pressure differential between the condenser 116 and the piston cylinder 108. As the vaporized working fluid enters the condenser 116, the working fluid may rapidly cool, such that the working fluid condenses. The condensation of the working fluid reduces the pressure exerted within the piston cylinder 108 by the working fluid, such that a partial vacuum is created within the piston cylinder 108. The piston 112 may then retract in direction D8 toward the retracted position 140.

The condensate of the working fluid may flow through the condenser 116 to the closed-loop return system 120, as indicated by arrow D9. The closed-loop return system 120 may return the condensate to the evaporator 104. At least in part due to the continuous flow of working fluid throughout the regenerative heat pipe cylinder 100, the method of producing mechanical work may operate continuously. The alternating heating and cooling phases producing vapor expansion and condensation, the cycle may naturally continue without input required from an operator.

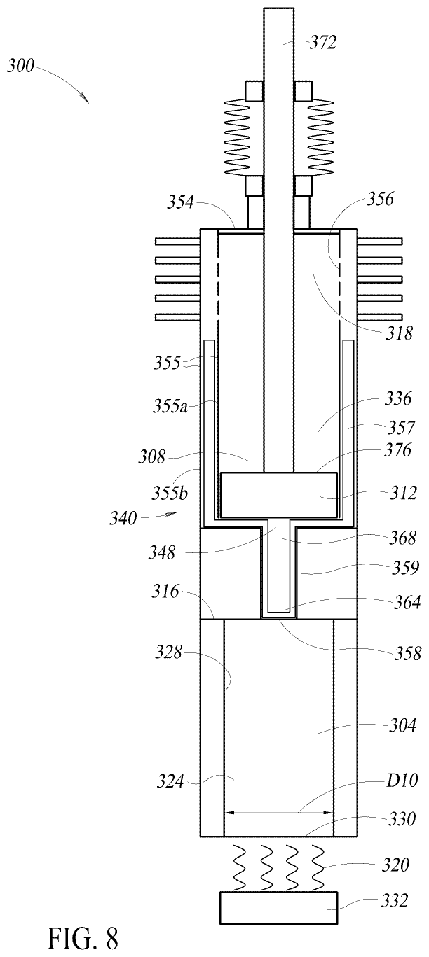

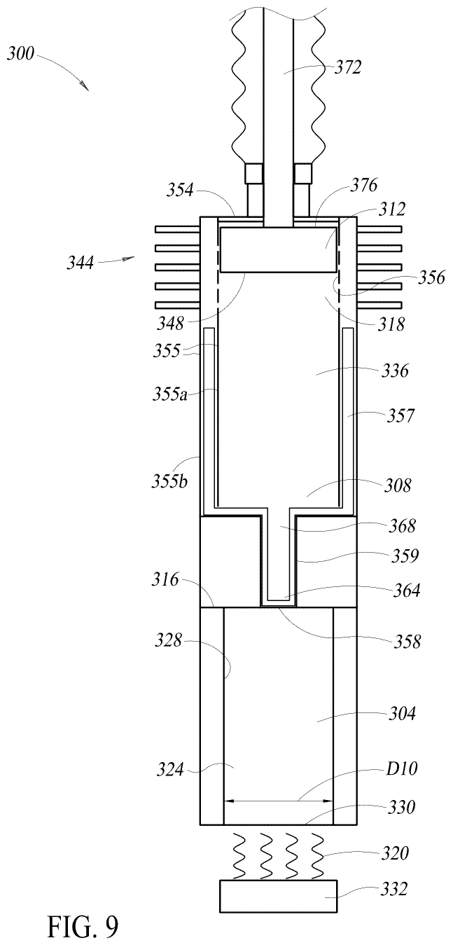

An alternative embodiment of a regenerative heat pipe cylinder 300 is shown in FIGS. 8 and 9. The regenerative heat pipe cylinder 300 includes an evaporator 304, a piston cylinder 308, a piston 312, a barrier 316, and a condenser 318.

The evaporator 304 is configured to absorb external thermal energy 320 and to vaporize a thermal fluid within the evaporator 304. The evaporator 304 may define an inner chamber 324 in which the thermal fluid may be disposed. In the embodiment shown in FIG. 8, the regenerative heat pipe cylinder 300 is configured such that the thermal fluid does not exit the inner chamber 324 during operation. Walls 328 defining the inner chamber 324 may be coated or constructed by high thermal conductivity material. The evaporator 304 may be configured to generally uniformly vaporize thermal fluid across a lateral dimension D10 of the evaporator 304. The evaporator 304 may be configured to absorb external energy 320 through the walls 328 or through a floor 330 of the evaporator 304.

The thermal fluid vaporized in the evaporator may preferably comprise water. In some embodiments, the working fluid may comprise organic fluids or any of helium, nitrogen, ammonia, acetone, methanol, ethanol, mercury sodium, lithium, or silver.

The external thermal energy 320 may be supplied to the evaporator 304 by way of any suitable external heat source 332, such as solar collectors, electric heaters, fuel powered heaters, geothermal heat, or waste heat sources. In some embodiments, external thermal energy 320 may be provided by any suitable fuel-powered heater, including heaters powered by natural gas, propane, butane, diesel, gasoline, oil, coal, wood, geothermal, or hydrogen. In some embodiments, the external thermal energy 320 may be provided by a thermal storage system, such as sand, rock, or phase change salts.

The piston cylinder 308 may be positioned above the evaporator 304. The piston 312 may be disposed within a piston chamber 336 of the piston cylinder 308 such that the piston 312 may translate within the piston cylinder 308. The piston 312 is shown in a retracted position 340 in FIG. 8 and is shown in an extended position 344 in FIG. 9.

The piston cylinder 308 may also house a working fluid therein. Specifically, the working fluid may be positioned on an evaporator side 348 of the piston 312. The piston 312 may be driven from the retracted position 340 to the extended position 344 by pressure exerted by the working fluid when the working fluid is expanded, for example, by way of heating of the working fluid. The piston 312 may be configured such that the working fluid remains on the evaporator side 348 of the piston 312.

The piston cylinder 308 may be separated from the evaporator 304 by way of the barrier 316 therebetween. The barrier 316 may prevent fluid flowing from one of the evaporator 304 or the piston cylinder 308 to the other. The barrier 316 may be configured to enable heat transfer therethrough.

The condenser 318 may be incorporated into the piston cylinder 308, such that the condenser 318 forms the first end 354 of the piston cylinder 308. The condenser 318 is configured to condense vapor when the piston 312 reaches the extended position 344. The piston cylinder 308 may include a pair of walls 355. An inner wall 355a of the pair of walls 355 may extend around a circumference of the piston cylinder 308. An outer wall 355b of the pair of walls 355 may extend around the inner wall 355b. The inner wall 355a may include perforations 356 on the first end 354 of the piston cylinder 308 which are configured to enable condensed vapor to travel therethrough. In some embodiments, a closed-loop fluid return system 357 may extend, at least partially between the pair of walls 355.

The closed-loop fluid return system 357 may be fluidically coupled to the condenser 318 and configured to transport the condensate from the condenser 318 to a position 358 adjacent to the barrier 316. The closed-loop fluid return system 357 may be configured to continuously recirculate the condensate to the position 358 adjacent to the barrier 316. Such a configuration enables continuous, self-sustaining operation. In some embodiments, the closed-loop fluid return system 357 may comprise a wick structure, The wick structure may comprise any of copper braids, fiberglass blanket, carbon fiber weave, or stainless-steel wool. In some embodiments, the closed-loop fluid return system 357 may comprise a gravity-assisted channel. In some embodiments, the closed-loop fluid return system 357 may at least partly operate by way of capillary action.

During operation of the regenerative heat pipe cylinder 300, the working fluid may be heated by the thermal fluid via heat transfer through the barrier 316. The working fluid may expand due to the additional energy, and thus, may drive the piston 312 from the retracted position 340 to the extended position 344. As the working fluid expands and drives the piston 312, the working fluid moves away from the barrier 316 and may begin to cool. In some embodiments, the working fluid may be cooled by way of the condenser 318, which may be incorporated into a first end 354 of the piston cylinder 308. As the working fluid cools, the working fluid may condense and may be removed to the condenser 318, and exert less pressure on the piston 312, such that the piston 312 may retract and return to the retracted position 340. As the piston 312 returns to the retracted position 340, the working fluid may again be positioned such that energy is received via heat transfer through the barrier 316. Operation of the regenerative heat pipe cylinder 300 may repeatedly continue due to the repetitive heating and cooling of the working fluid.

In some embodiments, a phase transition heat pipe 359 may be fluidically coupled to the piston cylinder 308 and may be positioned between the piston cylinder 308 and the evaporator 304. The phase transition heat pipe 359 may include a hot end 364, which is at the position 358 adjacent to the barrier 316, and a cold end 368 on the opposite end of the phase transition heat pipe 359. The piston 312 may seal the phase transition heat pipe 359 on the cold end 368 when the piston 312 is in the retracted position 340. The working fluid may be heated when present at the hot end 364 of the phase transition heat pipe 359. As the working fluid is heated by the heat provided through the barrier 316, the working fluid may vaporize and rise toward the cold end 368 of the phase transition heat pipe 359 and drive the piston 312 from the retracted position 340 to the extended position 344. As the vaporized working fluid is condensed and transported, the working fluid may be returned to the hot end 364 of the phase transition heat pipe 359. The condensed working fluid may be returned to the hot end 364 of the phase transition heat pipe 359 at least partially by way of the closed-loop fluid return system 357. Additionally or alternatively, the working fluid may be returned to the hot end 364 of the phase transition heat pipe 359 by way of any of capillary action or gravity.

The piston 312 may include a piston rod 372 extending from a free side 376 of the piston 312, which is opposite the evaporator side 348 of the piston 312. The piston rod 372 may couple to a transmission or energy transfer device.

Although not described with reference to FIGS. 8 and 9, it should be understood that the regenerative heat pipe cylinder 300 may include any of the features described in connection with FIGS. 1 through 4, including but not limited to, a piston return enhancement mechanism, a stuffing box, a pressure barrier, a purge valve, and/or a feed valve.

The regenerative heat pipe cylinder 300 may be incorporated into the regenerative phase-change engine 210 shown in FIG. 5 in place of the regenerative heat pipe cylinder 100. The regenerative heat pipe cylinder 300 may be directly coupled to a generator or a mechanical work output machine, such as a linear alternator, as described above with reference to the regenerative heat pipe cylinder 100.

The regenerative heat pipe cylinders and associated energy transfer systems described herein may be adapted to a variety of implementations, including those not related to off-grid power generation. Such regenerative heat pipe cylinders may provide improved continuous use of energy generation or conversion in a number of settings, including those which may supplement other forms of energy generation or conversion.

The devices and systems of the disclosure each have several innovative aspects, no single one of which is solely responsible or required for the desirable attributes disclosed herein. The various features described above may be used independently of one another, or may be combined in various ways. All possible combinations and subcombinations are intended to fall within the scope of this disclosure. Various modifications to the implementations described in this disclosure may be readily apparent to those of ordinary skill in the art, and the generic principles defined herein may be applied to other implementations. Thus, the claims are not intended to be limited to the implementations shown herein, but are to be accorded the widest scope consistent with this disclosure, the principles and the novel features disclosed herein.

Certain features that may be described in this specification in the context of separate implementations also may be implemented in combination in a single implementation. Conversely, various features that may be described in the context of a single implementation also may be implemented in multiple implementations separately or in any suitable subcombination. Moreover, although features may be described above as acting in certain combinations and even initially claimed as such, one or more features from a claimed combination can be excised from the combination, and the claimed combination may be directed to a subcombination or variation of a subcombination. No single feature or group of features is necessary or indispensable to each and every embodiment.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise.

In general, in the following claims, the terms used should not be construed to limit the claims to the specific embodiments disclosed in the specification and the claims, but should be construed to include all possible embodiments along with the full scope of equivalents to which such claims are entitled.

1. A regenerative heat pipe phase-change engine, comprising:
an evaporator configured to absorb external thermal energy and to vaporize a working fluid within the evaporator;
a piston cylinder fluidically coupled to the evaporator;
a piston configured to move within the piston cylinder, the piston configured to be driven by pressure exerted by the vapor generated in the evaporator;
a condenser fluidically coupled to the piston cylinder, the condenser configured to condense the vapor into a condensate, such that a pressure differential is created between the condensate and the vapor; and
a closed-loop fluid return system configured to transport condensate from the condenser to the evaporator.

2. The regenerative heat pipe phase-change engine of claim 1, wherein the evaporator is configured to absorb thermal energy from one or more external sources selected from the group consisting of solar collectors, electric heaters, fuel powered heaters, geothermal heat, and waste heat recovery systems.

3. The regenerative heat pipe phase-change engine of claim 1, further comprising a restrictor orifice positioned between the evaporator and the piston cylinder, the restrictor orifice configured to regulate a vapor flow rate from the evaporator to the piston cylinder.

4. The regenerative heat pipe phase-change engine of claim 1, wherein the condenser is configured to condense the vapor such that the working fluid undergoes a phase-change to a liquid, and such that at least a partial vacuum is generated in the piston cylinder.

5. The regenerative heat pipe phase-change engine of claim 1, wherein the closed-loop fluid return system is configured to continuously recirculate the condensate to the evaporator by way of at least one of a gravity-assisted channel, capillary action, or a wick structure.

6. The regenerative heat pipe phase-change engine of claim 1, further comprising a piston return enhancement mechanism configured to bias the piston in a direction of the evaporator.

7. The regenerative heat pipe phase-change engine of claim 6, wherein the piston return enhancement mechanism is a mechanical spring.

8. The regenerative heat pipe phase-change engine of claim 1, wherein the piston is coupled to a modular mechanical system configured to convert mechanical energy produced by movement of the piston into electrical energy.

9. The regenerative heat pipe phase-change engine of claim 1, wherein the condenser is a heat exchanger.

10. A method of producing mechanical work, comprising:
vaporizing a working fluid within an evaporator;
driving a piston within a piston cylinder by way of pressure exerted by the vapor generated in the evaporator;
condensing the vapor driving the piston into a condensate, such that the pressure differential between the vapor and the condensate retracts the piston; and
returning the condensate to the evaporator by way of a closed-loop fluid return system.

11. The method of producing mechanical work of claim 10, further comprising heating the evaporator with one or more external heat sources selected from the group consisting of solar collectors, electric heaters, fuel powered heaters, geothermal heat, and waste heat recovery systems.

12. The method of producing mechanical work of claim 10, wherein vapor generated in the evaporator flows through a restrictor orifice to reach the piston, the restrictor orifice configured to regulate a vapor flow rate from the evaporator to the piston.

13. The method of producing mechanical work of claim 10, wherein condensing the vapor driving the piston into a condensate causes the vapor such that the working fluid undergoes a phase-change to a liquid, and such that at least a partial vacuum is generated in the piston cylinder.

14. The method of producing mechanical work of claim 10, wherein returning the condensate to the evaporator is continuous by way of at least one of a gravity-assisted channel, capillary action, or a wick structure.

15. The method of producing mechanical work of claim 10, wherein retraction of the piston is caused by the pressure differential between the vapor and the condensate and by a piston return enhancement mechanism biasing the piston in a direction of the evaporator.

16. The method of producing mechanical work of claim 15, wherein the piston return enhancement mechanism is a mechanical spring.

17. The method of producing mechanical work of claim 10, further comprising converting mechanical energy produced by movement of the piston into electrical energy by way of modular mechanical system coupled to the piston.

18. An expansible heat pipe phase-change engine, comprising:
an evaporator configured to absorb external thermal energy and to vaporize a thermal fluid within the evaporator;
a piston cylinder housing a piston and a working fluid, the working fluid on an evaporator side of the piston and configured to exert increased pressure when heated such that the heated working fluid drives the piston; and
a barrier positioned between the evaporator and the piston cylinder configured to separate the thermal fluid and the working fluid, the barrier configured to enable heat transfer therethrough,
wherein the working fluid is configured to be heated by the vaporized thermal fluid in the evaporator.

19. The expansible heat pipe phase-change engine of claim 18, wherein the piston cylinder is configured such that the heated working fluid cools or is removed to the condenser when the piston is in a fully extended position, wherein the piston is configured to retract when the working fluid cools or is removed by way of reduced pressure exerted by the working fluid.

20. The expansible heat pipe phase-change engine of claim 18, wherein the piston is coupled to a modular mechanical system configured to convert mechanical energy produced by movement of the piston into electrical energy.
